(19) United States
(12) Patent Application Publication
(10) Pub. No.: US 2015/0324004 A1
(43) Pub. Date: Nov. 12, 2015

(54) ELECTRONIC DEVICE AND METHOD FOR RECOGNIZING GESTURE BY ELECTRONIC DEVICE

(71) Applicant: Samsung Electronics Co., Ltd., Suwon-si (KR)

(72) Inventors: Donghan LEE, Suwon-si (KR); Jeongho CHO, Suwon-si (KR)

(21) Appl. No.: 14/706,212

(22) Filed: May 7, 2015

(30) Foreign Application Priority Data
May 12, 2014 (KR) 10-2014-0056364

(51) Int. Cl. G06F 3/01

(52) U.S. Cl. CPC G06F 3/017

(57) ABSTRACT

An electronic device and a method for recognizing a gesture by the electronic device are provided. The method includes sensing a change amount of a signal strength received through one or more channels by using a gesture sensor including the one or more channels, generating valid data according to the sensed change amount of the signal strength, recognizing a speed of the gesture according to the generated valid data, and determining the gesture according to the sensed change amount of the signal strength and the generated valid data.

### CROSS-REFERENCE TO RELATED APPLICATION(S)

This application claims the benefit under 35 U.S.C. §119(a) of a Korean patent application filed on May 12, 2014 in the Korean Intellectual Property Office and assigned Serial No. 10-2014-0056364, the entire disclosure of which is hereby incorporated by reference.

### TECHNICAL FIELD

The present disclosure relates to a method for recognizing a gesture of a user by an electronic device.

### BACKGROUND

Recently, an electronic device, particularly, a portable terminal, includes an infrared sensor, a camera, etc. and provides a user input scheme using a sensor for proximity sensing. Such a function enables a user to deliver a gesture from the user to the portable terminal even without directly contacting a touch screen.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for recognizing, through a sensor of an electronic device, a movement (hereinafter referred to as a “gesture”) as an input to the electronic device that a user makes by using an object (e.g., a hand as a body part of a person, or a stylus pen) located outside the electronic device, and the electronic device including an apparatus for implementing the method. Another aspect of the present disclosure is to accurately implement an operation, which is desired by the user, by determining the area and speed of the gesture made by the user.

In accordance with an aspect of the present disclosure, a method for recognizing a gesture by an electronic device is provided. The method includes sensing a change amount of a signal strength received through one or more channels by using a gesture sensor including the one or more channels, generating valid data according to the sensed change amount of the signal strength, recognizing a speed of the gesture according to the generated valid data, and determining the gesture according to the sensed change amount of the signal strength and the generated valid data.

In accordance with another aspect of the present disclosure, an electronic device is provided. The electronic device includes a display, a gesture sensor, and a processor, wherein the processor may sense a change amount of a signal strength received through one or more channels by using a gesture sensor including the one or more channels, may generate valid data according to the sensed change amount of the signal strength, may recognize a speed of the gesture according to the generated valid data, and may determine the gesture according to the sensed change amount of the signal strength and the generated valid data.

The electronic device and the method for recognizing a gesture by the electronic device, according to various embodiments of the present disclosure, can determine a speed and an area of an object that has made the gesture, and thereby can not only recognize the gesture of a user more clearly but can also recognize the various gestures of the user. Moreover, the electronic device and the method for recognizing the gesture by the electronic device can determine the speed and area of the object that has made the gesture, and thus can display various user interfaces according to the speed and area of the object that has made the gesture.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a network environment including an electronic device according to an embodiment of the present disclosure;

FIG. 2 is a block diagram illustrating a configuration of an electronic device according to embodiments of the present disclosure;

FIGS. 3A and 3B are views illustrating an operation of an electronic device including a sensor module according to an embodiment of the present disclosure;

FIG. 4 is a graph illustrating a gesture recognition operation of an electronic device according to an embodiment of the present disclosure;

FIG. 5 is a graph illustrating a method for recognizing a speed of a gesture by an electronic device according to an embodiment of the present disclosure;

FIGS. 6A and 6B are views illustrating a method for recognizing a speed of a gesture according to the size of an external object by an electronic device according to an embodiment of the present disclosure;

FIGS. 7A and 7B are graphs illustrating a method for recognizing a speed of a gesture according to the size of an external object by an electronic device according to an embodiment of the present disclosure;

FIG. 8 is a flowchart illustrating a method for recognizing a gesture by an electronic device according to an embodiment of the present disclosure;

FIGS. 9A, 9B, and 9C are views illustrating examples of a user interface displayed by using a method for recognizing a gesture according to various embodiments of the present disclosure;

FIGS. 10A and 10B are views illustrating examples of a user interface displayed by using a method for recognizing a gesture according to various embodiments of the present disclosure;

FIGS. 11A and 11B are views illustrating examples of a user interface displayed by using a method for recognizing a gesture according to various embodiments of the present disclosure;

FIGS. 12A and 12B are views illustrating examples of a user interface displayed by using a method for recognizing a gesture according to various embodiments of the present disclosure;

FIGS. 13A and 13B are views illustrating examples of a user interface displayed by using a method for recognizing a gesture according to various embodiments of the present disclosure; and

FIGS. 14A and 14B are views illustrating examples of a user interface displayed by using a method for recognizing a gesture according to various embodiments of the present disclosure.

Throughout the drawings, it should be noted that like reference numbers are used to depict the same or similar elements, features, and structures.

### DETAILED DESCRIPTION

In the related art, when a gesture is received through a sensor, only the direction of an intended gesture (or movement of an object) is determined, and thus it may be difficult to determine the size of the object outside of an electronic device that has made and input the gesture. For example, a user may input a gesture (or movement of an object) by using a palm, a hand knife, or a finger of the user. In this case, the sensor cannot sense a speed of the object outside of the electronic device (or the external object), and thus an unintended gesture (or movement of the object) may be recognized.

Accordingly, there is a need for a method and an apparatus capable of recognizing, effectively and according to the user's intention, the gesture of the user in an electronic device including a sensor for recognizing a gesture. Various embodiments of the present disclosure may provide a method and an apparatus capable of more clearly recognizing a gesture of the user received through the sensor and recognizing the various gestures of the user. Further, various embodiments of the present disclosure enable the user to intuitively generate a user input using the sensor, and thereby can improve the convenience of the user.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions “1”, “2”, “first”, “second”, etc. used in various embodiments of the present disclosure may modify various components of the various embodiments but do not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “coupled to” or “connected to” another component, the component may be directly coupled or connected to another component or a new component may exist between the component and another component. In contrast, when it is stated that a component is “directly coupled to” or “directly connected to” another component, a new component does not exist between the component and another component.

The terms used in describing various embodiments of the present disclosure are only examples for describing a specific embodiment but do not limit the various embodiments of the present disclosure. Singular forms are intended to include plural forms unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

An electronic device according to various embodiments of the present disclosure may be a device including a communication function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HMD)) such as electronic glasses, electronic clothes, and electronic bracelet, an electronic necklace, an electronic appcessary, an electronic tattoo, and a smart watch.

According to some embodiments, the electronic device may be a smart home appliance having a communication function. The smart home appliance may include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame.

According to some embodiments, the electronic device may include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Positioning System (GPS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops.

According to some embodiments, the electronic device may include at least one of furniture or a part of a building/structure, an electronic board, an electronic signature receiving device, a projector, and various types of measuring devices (for example, a water meter, an electricity meter, a gas meter, a radio wave meter and the like) including a camera function. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) which uses an electronic device.

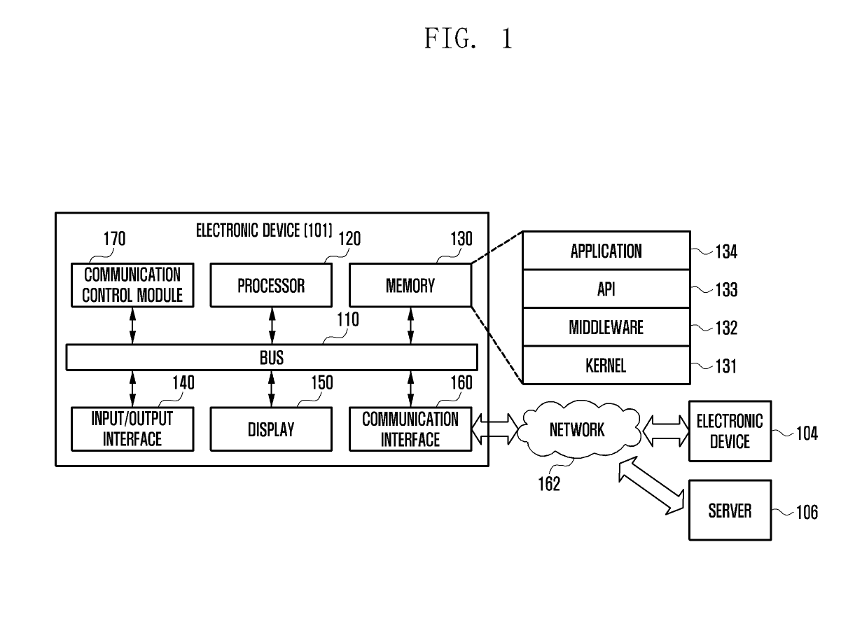

FIG. 1 is a view illustrating a network environment including an electronic device according to various embodiments of the present disclosure.

Referring to FIG. 1, the electronic device 101 includes a bus 110, a processor 120, a memory 130, an input/output interface 140, a display 150, a communication interface 160, and a communication control module 170.

The bus 110 may be a circuit connecting the above described components and transmitting communication (for example, a control message) between the above described components.

The processor 120 receives commands from other components (for example, the memory 130, the input/output interface 140, the display 150, the communication interface 160, or the communication control module 170) through the bus 110, analyzes the received commands, and executes calculation or data processing according to the analyzed commands.

The memory 130 stores commands or data received from the processor 120 or other components (for example, the input/output interface 140, the display 150, the communication interface 160, or the communication control module 170) or generated by the processor 120 or other components. The memory 130 may include programming modules, for example, a kernel 131, middleware 132, an Application Programming Interface (API) 133, and an application 134. Each of the aforementioned programming modules may be implemented by software, firmware, hardware, or a combination of two or more thereof.

The kernel 131 controls or manages system resources (for example, the bus 110, the processor 120, or the memory 130) used for executing an operation or function implemented by the remaining other programming modules, for example, the middleware 132, the API 133, or the application 134. Further, the kernel 131 provides an interface for accessing individual components of the electronic device 101 from the middleware 132, the API 133, or the application 134 to control or manage the components.

The middleware 132 performs a relay function of allowing the API 133 or the application 134 to communicate with the kernel 131 to exchange data. Further, in operation requests received from the application 134, the middleware 132 performs a control for the operation requests (for example, scheduling or load balancing) by using a method of assigning a priority, by which system resources (for example, the bus 110, the processor 120, the memory 130 and the like) of the electronic device 101 can be used, to the application 134.

The API 133 is an interface by which the application 134 can control a function provided by the kernel 131 or the middleware 132 and includes, for example, at least one interface or function (for example, command) for a file control, a window control, image processing, or a character control.

According to various embodiments, the application 134 may include a Short Message Service (SMS)/Multimedia Messaging Service (MMS) application, an email application, a calendar application, an alarm application, a health care application (for example, application measuring quantity of exercise or blood sugar) or an environment information application (for example, application providing information on barometric pressure, humidity or temperature). Additionally or alternatively, the application 134 may be an application related to an information exchange between the electronic device 101 and an external electronic device (for example, an electronic device 104). The application related to the information exchange may include, for example, a notification relay application for transferring particular information to the external electronic device or a device management application for managing the external electronic device.

For example, the notification relay application may include a function of transmitting notification information generated by another application (for example, an SMS/MMS application, an email application, a health care application or an environment information application) of the electronic device 101 to the external electronic device (for example, the electronic device 104). Additionally or alternatively, the notification relay application may receive notification information from, for example, the external electronic device 104 and provide the received notification information to the user. The device management application may manage (for example, install, remove, or update) at least a part of functions (for example, turning on/off the external electronic device (or some components of the external electronic device) or controlling a brightness of the display) of the external electronic device (104 communicating with the electronic device 101, an application executed in the external electronic device 104, or a service (for example, call service or message service) provided by the external electronic device 104.

According to various embodiments, the application 134 may include an application designated according to an attribute (for example, type of electronic device) of the external electronic device 104. For example, when the external electronic device 104 is an MP3 player, the application 134 may include an application related to music reproduction. Similarly, when the external electronic device 104 is a mobile medical device, the application 134 may include an application related to health care. According to an embodiment, the application 134 may include at least one of an application designated to the electronic device 101 and an application received from an external electronic device (for example, a server 106 or electronic device 104).

The input/output interface 140 transmits a command or data input from the user through an input/output device (for example, a sensor, a keyboard, or a touch screen) to the processor 120, the memory 130, the communication interface 160, or the communication control module 170 through, for example, the bus 110. For example, the input/output interface 140 may provide data on a user's touch input through a touch screen to the processor 120. Further, the input/output interface 140 may output a command or data received, through, for example, the bus 110, from the processor 120, the memory 130, the communication interface 160, or the communication control module 170 through the input/output device (for example, a speaker or a display). For example, the input/output interface 140 may output voice data processed through the processor 120 to the user through the speaker.

The display 150 displays various pieces of information (for example, multimedia data, text data, or the like) for the user.

The communication interface 160 establishes communication between the electronic device 101 and the external device (for example, the electronic device 104 or the server 106). For example, the communication interface 160 may access a network 162 through wireless or wired communication to communicate with the external device. The wireless communication includes at least one of, for example, WiFi, BlueTooth (BT), Near Field Communication (NFC), a GPS, and cellular communication (for example, LTE, LTE-A, CDMA, WCDMA, UMTS, WiBro or GSM). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the network 162 may be a telecommunication network. The telecommunication network includes at least one of a computer network, the Internet, an Internet of things, and a telephone network. According to an embodiment, a protocol (for example, a transport layer protocol, a data link layer protocol, or a physical layer protocol) for communication between the electronic device 101 and the external device may be supported by at least one of the application 134, the application programming interface 133, the middleware 132, the kernel 131, and the communication interface 160.

According to an embodiment, the server 106 supports driving of the electronic device 101 by performing at least one operation (or function) implemented by the electronic device 101. For example, the server 106 may include a communication control server module (not shown) that supports the communication control module 170 implemented in the electronic device 101. For example, the communication control server module may include at least one of the components of the communication control module 170 to perform (on behalf of) at least one operations performed by the communication control module 170.

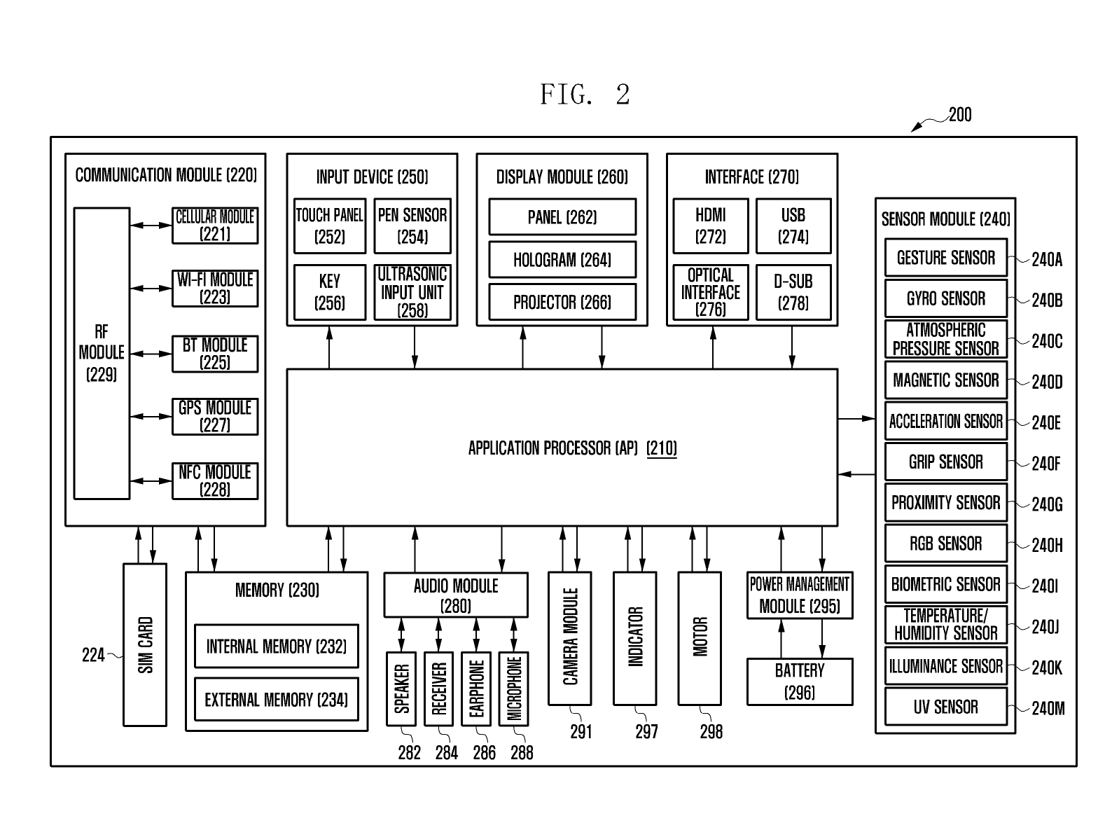

FIG. 2 is a block diagram illustrating a configuration of an electronic device according to various embodiments of the present disclosure. The electronic device of FIG. 2 may configure, for example, a whole or a part of the electronic device 101 illustrated in FIG. 1.

Referring to FIG. 2, the electronic device 200 includes one or more Application Processors (APs) 210, a communication module 220, a Subscriber Identification Module (SIM) card 224, a memory 230, a sensor module 240, an input device 250, a display module 260, an interface 270, an audio module 280, a camera module 291, a power management module 295, a battery 296, an indicator 297, and a motor 298.

The AP 210 operates an operating system (OS) or an application program so as to control a plurality of hardware or software component elements connected to the AP 210 and execute various data processing and calculations including multimedia data. The AP 210 may be implemented by, for example, a System on Chip (SoC). According to an embodiment, the processor 210 may further include a Graphic Processing Unit (GPU).

The communication module 220 (for example, communication interface 160) transmits/receives data in communication between different electronic devices (for example, the electronic device 104 and the server 106) connected to the electronic device 200 (for example, electronic device 101) through a network. According to an embodiment, the communication module 220 includes a cellular module 221, a WiFi module 223, a BT module 225, a GPS module 227, a NFC module 228, and a Radio Frequency (RF) module 229.

The cellular module 221 provides a voice, a call, a video call, an SMS, or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 221 may distinguish and authenticate electronic devices within a communication network by using a SIM (for example, the SIM card 224). According to an embodiment, the cellular module 221 performs at least some of the functions which can be provided by the AP 210. For example, the cellular module 221 may perform at least some of the multimedia control functions.

According to an embodiment, the cellular module 221 may include a Communication Processor (CP). Further, the cellular module 221 may be implemented by, for example, an SoC.

Although the components such as the cellular module 221 (for example, CP), the memory 230, and the power management module 295 are illustrated as components separate from the AP 210 in FIG. 2, the AP 210 may include at least some (for example, cellular module 221) of the aforementioned components in an embodiment.

According to an embodiment, the AP 210 or the cellular module 221 (for example, CP) may load a command or data received from at least one of a non-volatile memory and other components connected to each of the AP 210 and the cellular module 221 to a volatile memory and process the loaded command or data. Further, the AP 210 or the cellular module 221 may store data received from at least one of other components or generated by at least one of other components in a non-volatile memory.

Each of the WiFi module 223, the BT module 225, the GPS module 227, and the NFC module 228 may include, for example, a processor for processing data transmitted/received through the corresponding module. Although the cellular module 221, the WiFi module 223, the BT module 225, the GPS module 227, and the NFC module 228 are illustrated as blocks separate from each other in FIG. 2, at least some (for example, two or more) of the cellular module 221, the WiFi module 223, the BT module 225, the GPS module 227, and the NFC module 228 may be included in one Integrated Chip (IC) or one IC package according to one embodiment. For example, at least some (for example, the CP corresponding to the cellular module 221 and the WiFi processor corresponding to the WiFi module 223) of the processors corresponding to the cellular module 221, the WiFi module 223, the BT module 225, the GPS module 227, and the NFC module 228 may be implemented by one SoC.

The RF module 229 transmits/receives data, for example, an RF signal. Although not illustrated, the RF module 229 may include, for example, a transceiver, a Power Amplifier Module (PAM), a frequency filter, a Low Noise Amplifier (LNA) or the like. Further, the RF module 229 may further include a component for transmitting/receiving electronic waves over a free air space in wireless communication, for example, a conductor, a conducting wire, or the like. Although the cellular module 221, the WiFi module 223, the BT module 225, the GPS module 227, and the NFC module 228 share one RF module 229 in FIG. 2, at least one of the cellular module 221, the WiFi module 223, the BT module 225, the GPS module 227, and the NFC module 228 may transmit/receive an RF signal through a separate RF module according to one embodiment.

The SIM card 224 is a card including a SIM and may be inserted into a slot formed in a particular portion of the electronic device. The SIM card 224 includes unique identification information (for example, Integrated Circuit Card IDentifier (ICCID)) or subscriber information (for example, International Mobile Subscriber Identity (IMSI).

The memory 230 (for example, memory 130) may include an internal memory 232 or an external memory 234. The internal memory 232 may include, for example, at least one of a volatile memory (for example, a Random Access Memory (RAM), a dynamic RAM (DRAM), a static RAM (SRAM), a synchronous dynamic RAM (SDRAM), and the like), and a non-volatile Memory (for example, a Read Only Memory (ROM), a one time programmable ROM (OTPROM), a programmable ROM (PROM), an erasable and programmable ROM (EPROM), an electrically erasable and programmable ROM (EEPROM), a mask ROM, a flash ROM, a NAND flash memory, an NOR flash memory, and the like).

According to an embodiment, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 234 may be functionally connected to the electronic device 200 through various interfaces. According to an embodiment, the electronic device 200 may further include a storage device (or storage medium) such as a hard drive.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (for example, Red, Green, and Blue (RGB) sensor) 240H, a biometric sensor 240I, a temperature/humidity sensor 240J, an illumination (light) sensor 240K, and a Ultra Violet (UV) sensor 240M. Additionally or alternatively, the sensor module 240 may include, for example, a E-nose sensor, an electromyography (EMG) sensor, an electroencephalogram (EEG) sensor, an electrocardiogram (ECG) sensor, an InfraRed (IR) sensor, an iris sensor, a fingerprint sensor (not illustrated), and the like. The sensor module 240 may further include a control circuit for controlling one or more sensors included in the sensor module 240.

The input device 250 includes a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 can recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which can detect an acoustic wave by a microphone (for example, a microphone 288) of the electronic device 200 through an input means generating an ultrasonic signal to identify data and can perform wireless recognition. According to an embodiment, the electronic device 200 receives a user input from an external device (for example, computer or server) connected to the electronic device 200 by using the communication module 220.

The display module 260 (for example, display 150) may include a panel 262, a hologram device 264, and a projector 266. The panel 262 may be, for example, a Liquid Crystal Display (LCD) or an Active Matrix Organic Light Emitting Diode (AM-OLED). The panel 262 may be implemented to be, for example, flexible, transparent, or wearable. The panel 262 may be configured by the touch panel 252 and comprise one module. The hologram device 264 shows a stereoscopic image in the air by using interference of light. The projector 266 projects light on a screen to display an image. For example, the screen may be located inside or outside the electronic device 201. According to an embodiment, the display module 260 may further include a control circuit for controlling the panel 262, the hologram device 264, and the projector 266.

The interface 270 includes, for example, a High-Definition Multimedia Interface (HDMI) 272, a Universal Serial Bus (USB) 274, an optical interface 276, and a D-subminiature (D-sub) 278. The interface 270 may be included in, for example, the communication interface 160 illustrated in FIG. 1. Additionally or alternatively, the interface 290 may include, for example, a Mobile High-definition Link (MHL) interface, a Secure Digital (SD) card/Multi-Media Card (MMC), or an Infrared Data Association (IrDA) standard interface.

The audio module 280 bi-directionally converts a sound and an electronic signal. At least some components of the audio module 280 may be included in, for example, the input/output interface 140 illustrated in FIG. 1. The audio module 280 processes sound information input or output through, for example, a speaker 282, a receiver 284, an earphone 286, the microphone 288 or the like.

The camera module 291 is a device which can photograph a still image and a video. According to an embodiment, the camera module 291 may include one or more image sensors (for example, a front sensor or a back sensor), an Image Signal Processor (ISP) (not shown) or a flash (for example, an LED or xenon lamp).

The power management module 295 manages power of the electronic device 201. Although not illustrated, the power management module 295 may include, for example, a Power Management Integrated Circuit (PMIC), a charger Integrated Circuit (IC), or a battery or fuel gauge.

The PMIC may be mounted to, for example, an IC or an SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier or the like may be added.

The battery fuel gauge measures, for example, a remaining quantity of the battery 296, or a voltage, a current, or a temperature of the battery, for example during charging. The battery 296 may store or generate electricity and supply power to the electronic device 200 by using the stored or generated electricity. The battery 296 may include a rechargeable battery or a solar battery.

The indicator 297 shows particular statuses of the electronic device 200 or a part (for example, AP 210) of the electronic device 201, for example, a booting status, a message status, a charging status and the like. The motor 298 converts an electrical signal to a mechanical vibration.

Although not illustrated, the electronic device 200 may include a processing unit (for example, GPU) for supporting a module TV. The processing unit for supporting the mobile TV may process, for example, media data according to a standard of Digital Multimedia Broadcasting (DMB), Digital Video Broadcasting (DVB), media flow or the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, one or more of the components may be omitted, or additional components may be further included. Also, some of the components of the electronic device according to various embodiments of the present disclosure may be combined to form a single entity, and thus may equivalently execute functions of the corresponding components before being combined.

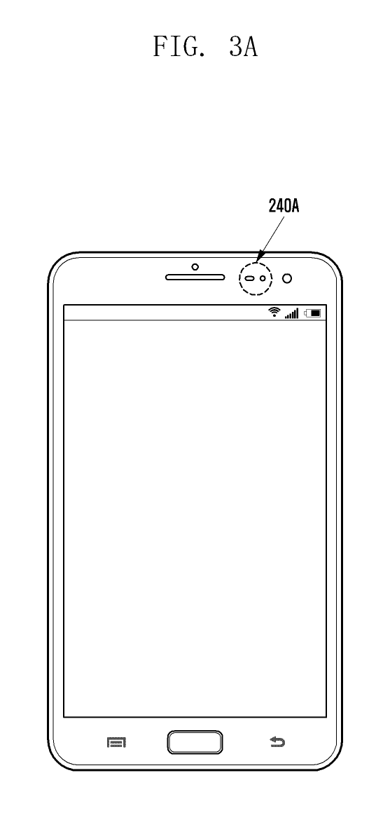

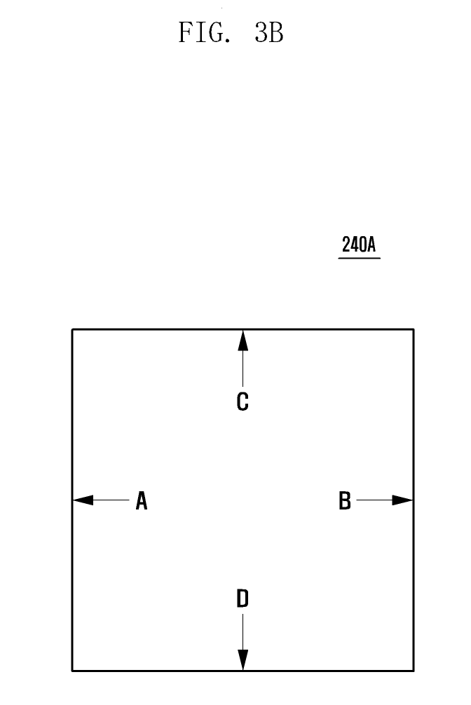

FIGS. 3A and 3B are views illustrating an operation of an electronic device including a gesture sensor according to an embodiment of the present disclosure.

Referring to FIGS. 3A and 3B, the electronic device may sense a gesture of the user by using at least one of a proximity sensor 240G and an illuminance sensor 240K, which can sense the gesture of the user among a sensor module 240, instead of the gesture sensor 240A capable of sensing the gesture of the user. The gesture sensor 240A may include a light-emitting unit for emitting light, which has a frequency corresponding to infrared light, to an object (e.g., a hand) and a light reception unit for receiving light reflected by the object approaching the electronic device 200. The gesture sensor 240A may receive, through the light reception unit, light reflected when infrared light emitted by the light-emitting unit hits the object, may sense a change amount of intensity of the reflected light, and thereby may sense a movement of the object and a distance to the object. The gesture sensor 240A may be one of a transmissive photoelectric sensor, a direct reflective photoelectric sensor, a mirror reflective photoelectric sensor, a capacitance-type sensor, a high-frequency oscillation-type sensor, an Infrared Ray (IR) sensor, a Light Emitting Diode (LED) sensor, an image sensor, an ultrasonic sensor, an electromagnetic induction sensor, and/or a touch sensor. The gesture sensor 240A may detect whether the external object exists, the approach of the external object, a movement thereof, a direction thereof, a speed thereof, a shape thereof, and the like, which occur on a sensing surface.

The gesture sensor 240A may include at least one channel, through which light can be received. According to an embodiment of the present disclosure, the gesture sensor 240A may calculate a change amount of each channel, a difference between change amounts of channels, and a sum of change amounts of channels.

According to an embodiment of the present disclosure, the light reception unit of the gesture sensor 240A may include A, B, C and D representing four channels which face left, right, upper and lower directions, respectively. By using data received through each channel, the processor 120 may calculate a difference between a change amount of a channel and that of another channel (e.g., a difference between a change amount of channel A and that of channel B, and/or a difference between a change amount of channel C and that of channel D), and a sum of the change amounts of the channels (e.g., a sum of a change amount of channel A, that of channel B, that of channel C and that of channel D). A change amount of a channel refers to a difference between strengths of signals received through the channel. As an example, a change amount of each channel may be a change amount of light received through each channel of the gesture sensor 240A. A difference between change amounts refers to a difference in change amount between channels.

A processor (e.g., processor 120) may determine a direction of a gesture (or movement of an object) by using a change amount of at least one channel. The processor 120 may determine a direction of a gesture (or movement of an object) by using a difference between a change amount of a channel and that of another channel (e.g., a difference between a change amount of channel A and that of channel B, and/or a difference between a change amount of channel C and that of channel D), and a sum of the change amounts of the channels (e.g., a sum of the change amount of channel A, that of channel B, that of channel C and that of channel D). For example, while light of the same intensity is received through channel A, channel B, channel C and channel D, if the intensity of light received in the direction of channel A becomes lower, the electronic device 200 may determine that an input from the user (or a gesture of the user) is generated in the direction of channel A. While light of the same intensity is received through channel A, channel B, channel C and channel D, if the intensity of light received through one of channel A, channel B, channel C and channel D becomes lower, the electronic device 200 may determine that an input from the user (or a gesture of the user) is generated in the direction of the channel through which the received light becomes lower.

According to an embodiment of the present disclosure, a method will be described below for determining a direction of a gesture made by the user (or movement of an object) by using a difference between a change amount of a channel and that of another channel (e.g., a difference between a change amount of channel A and that of channel B, and/or a difference between a change amount of channel C and that of channel D), and a sum of the change amounts of the channels (e.g., a sum of the change amount of channel A, that of channel B, that of channel C and that of channel D).

When the user has made a gesture, the electronic device 200 may acquire a change amount of intensity of light received through each channel (or a change amount of each channel). The electronic device 200 may determine whether a sum of the change amounts of the light intensities sensed through the respective channels is greater than or equal to a determined threshold. For example, the processor 120 may generate a higher-order function and may produce a dynamically changeable threshold, by using a difference between a change amount of a channel and that of another channel (e.g., a difference between a change amount of channel A and that of channel B, and/or a difference between a change amount of channel C and that of channel D), and a sum of the change amounts of the channels (e.g., a sum of the change amount of channel A, that of channel B, that of channel C and that of channel D).

When it is determined that the sum of the change amounts of the light intensities sensed through the respective channels is greater than or equal to the determined threshold, the electronic device 200 may determine that the gesture of the user has occurred. In contrast, when it is determined that the sum of the change amounts of the light intensities sensed through the respective channels is less than the determined threshold, the electronic device 200 may determine that the gesture of the user has not occurred. In order to prevent the reception of an unintended gesture of the user, the electronic device 200 determines, based on the sum of the change amounts of all the channels, whether the gesture of the user has occurred. For example, when the intensity of light received through channel A is low and then increases and simultaneously, that of light received through channel B is high and then is reduced, it can be noted that the direction of the gesture of the user moves from the direction of channel A to that of channel B. As an example, the electronic device 200 may determine the direction of the gesture of the user when a difference between a change amount of channel A (or a change amount of intensity of light received through channel A) and a change amount of channel B (or a change amount of intensity of light received through channel B) is calculated in a unit of time. For example, when the intensity of light received through channel C is low and then increases and simultaneously, that of light received through channel D is high and then is reduced, it can be noted that the direction of the gesture of the user moves from the direction of channel C to that of channel D. As an example, the electronic device 200 may determine the direction of the gesture of the user when a difference between a change amount of channel C (or a change amount of intensity of light received through channel C) and a change amount of channel D (or a change amount of intensity of light received through channel D) is calculated in a unit of time.

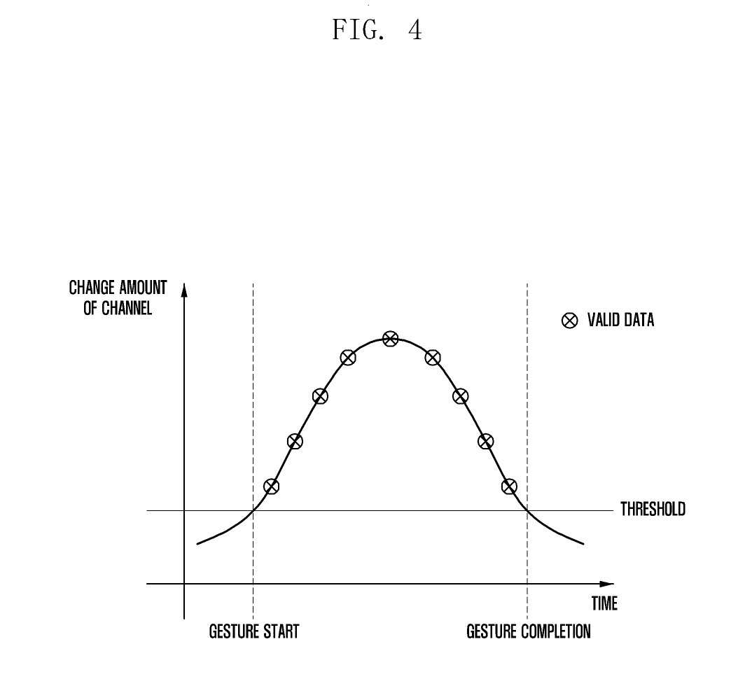

FIG. 4 is a graph illustrating a gesture recognition operation of an electronic device according to an embodiment of the present disclosure.

Referring to FIG. 4, the processor 120 may calculate a change amount of at least one channel by using the gesture sensor 240A. The processor 120 may produce a threshold by using the change amount of the at least one channel. When the change amount of the at least one channel exceeds the threshold, the processor 120 may determine that a gesture (or movement of an object) has occurred. For example, when the change amount of the at least one channel exceeds the threshold, the processor 120 may determine that a gesture has begun. In contrast, when the change amount of the at least one channel does not reach the threshold, the processor 120 may determine that the gesture does not occur or has been completed. The processor 120 may generate valid data by taking a sample per unit time of the change amount of the at least one channel which exceeds the threshold. Accordingly, the processor 120 may calculate a speed of the gesture by using the number of the valid data.

As an example, the processor 120 may calculate a change (i.e., increase or decrease) in a sum of the change amounts of the one or more channels received by the gesture sensor 240A. The processor 120 may produce a threshold by using a difference between a change amount of a channel and that of another channel (e.g., a difference between a change amount of channel A and that of channel B, and/or a difference between a change amount of channel C and that of channel D), and a sum of the change amounts of the channels (e.g., a sum of the change amount of channel A, that of channel B, that of channel C and that of channel D). When the sum of the change amounts of the respective channels exceeds the threshold, the processor 120 may determine that a gesture (or movement of an object) has occurred. For example, when the sum of the change amounts of the respective channels exceeds the threshold, the processor 120 may determine that the gesture has begun. In contrast, when the sum of the change amounts of the respective channels does not reach the threshold, the processor 120 may determine that the gesture does not occur or has been completed. The processor 120 may generate valid data by taking a sample per unit time of the sum of the change amounts of the respective channels which exceeds the threshold. Accordingly, the processor 120 may calculate a speed of the gesture by using the number of the valid data.

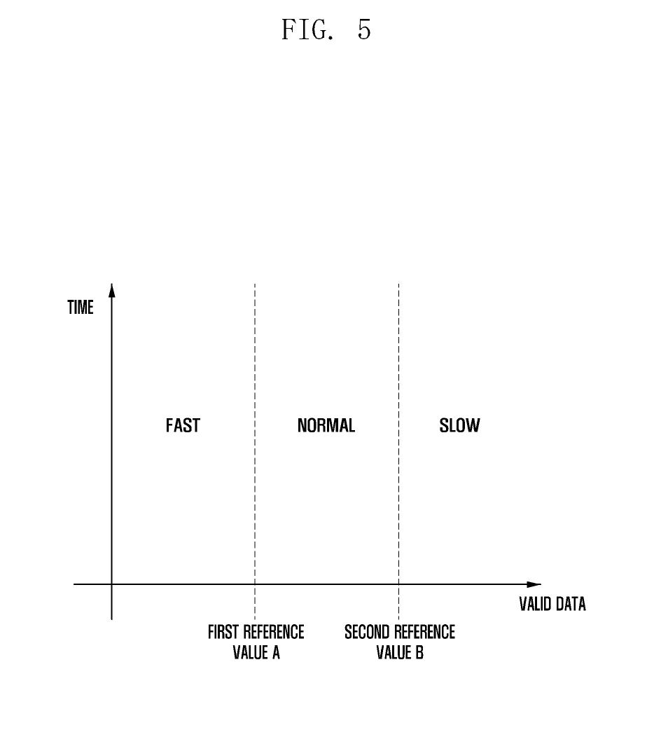

FIG. 5 is a graph illustrating a method for recognizing a speed of a gesture by an electronic device according to an embodiment of the present disclosure.

Referring to FIG. 5, the processor 120 may calculate the number of valid data in such a manner as to take a sample per unit time of the change amount of the at least one channel which exceeds the threshold. As an example, the processor 120 may calculate the number of valid data in such a manner as to take a sample per unit time of the change amount of the at least one channel which exceeds the threshold.

As an example, the processor 120 may calculate the number of valid data in such a manner as to take a sample per unit time of the sum of the change amounts of the respective channels which exceeds the threshold. The processor 120 may calculate the number of valid data in such a manner as to take a sample per unit time of the sum of the change amounts of the respective channels which exceeds the threshold.

For example, when the speed of a gesture (or movement of an object) is high, a time period from the start of the gesture to the completion thereof is shorter than when the speed of a gesture (or movement of an object) is low. Accordingly, the number of valid data which can be calculated is less than when the speed of a gesture is low. In contrast, when the speed of a gesture is low, a time period from the start of the gesture to the completion thereof is longer than when the speed of a gesture is high. Accordingly, the number of valid data which can be calculated is greater than when the speed of a gesture is high.

As an example, when the calculated number of the valid data is less than a first reference value, the processor 120 may determine that the gesture (or the movement of the object) is a gesture having a first speed. When the calculated number of the valid data is greater than a second reference value, the processor 120 may determine that the gesture is a gesture having a second speed. When the calculated number of the valid data is greater than the first reference value and is less than the second reference value, the processor 120 may determine that the gesture is a gesture having a third speed. The first or second reference value is used to calculate a speed of the valid data, and may be the number of valid data which is previously or dynamically determined. The second reference value is greater than the first reference value. The number of valid data determined as the second reference value implies that there are more valid data than in the case of the number of valid data determined as the first reference value. The processor 120 may determine that the gesture having the first speed is fastest among the gestures having the first speed to the third speed. The processor 120 may determine that the gesture having the second speed is slowest among the gestures having the first speed to the third speed. The processor 120 may determine that, among the gestures having the first speed to the third speed, the gesture having the third speed is a gesture having a speed ranging between the first speed and the second speed.

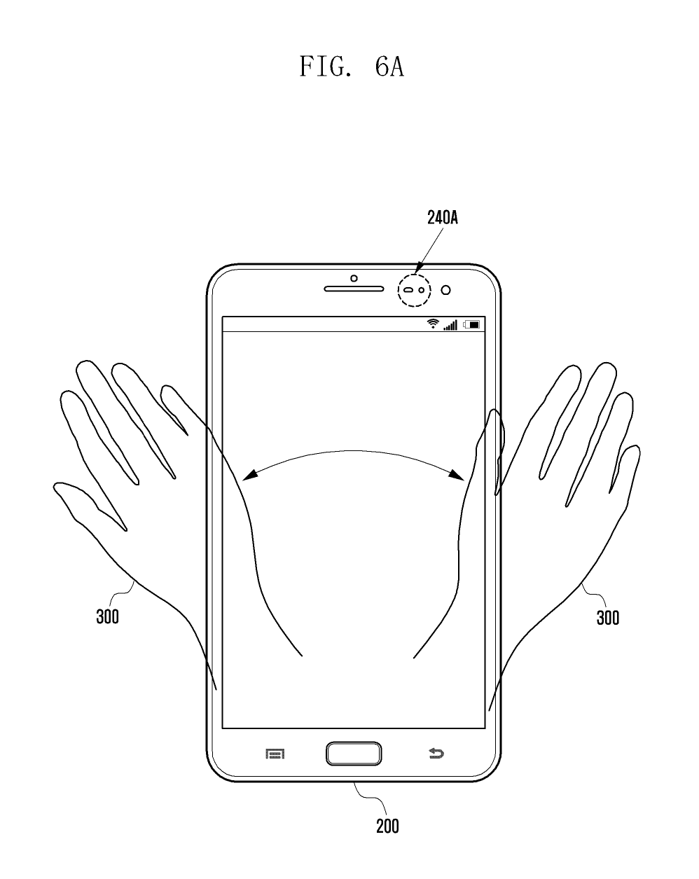

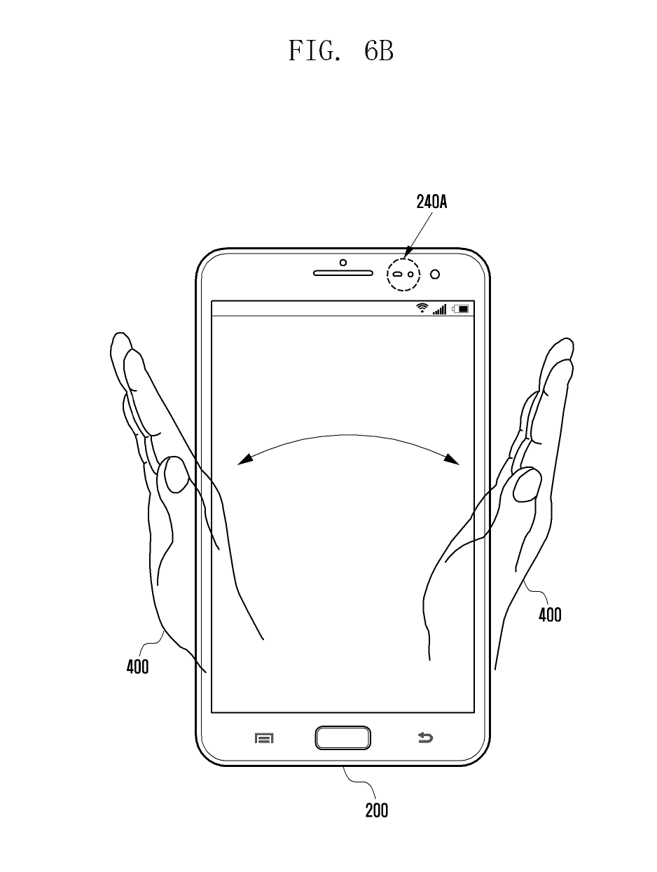

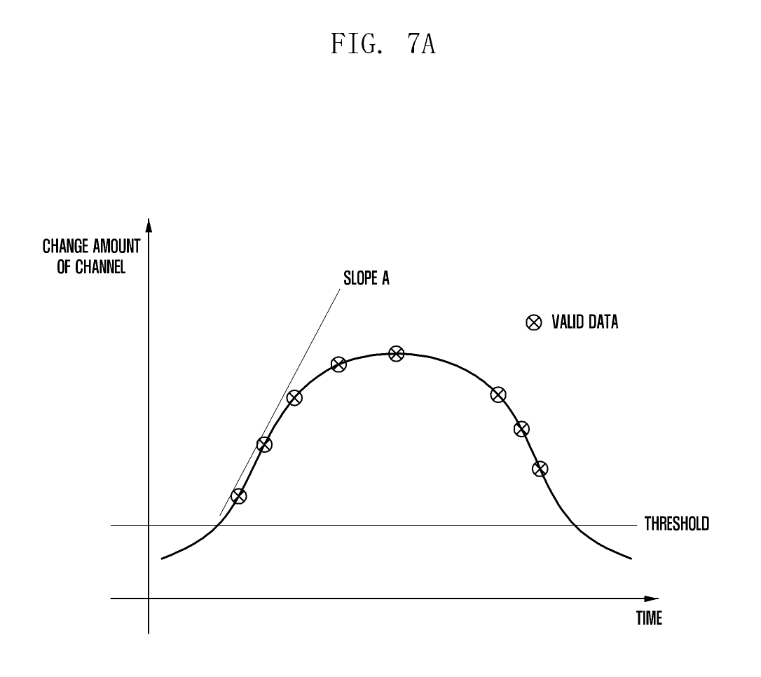

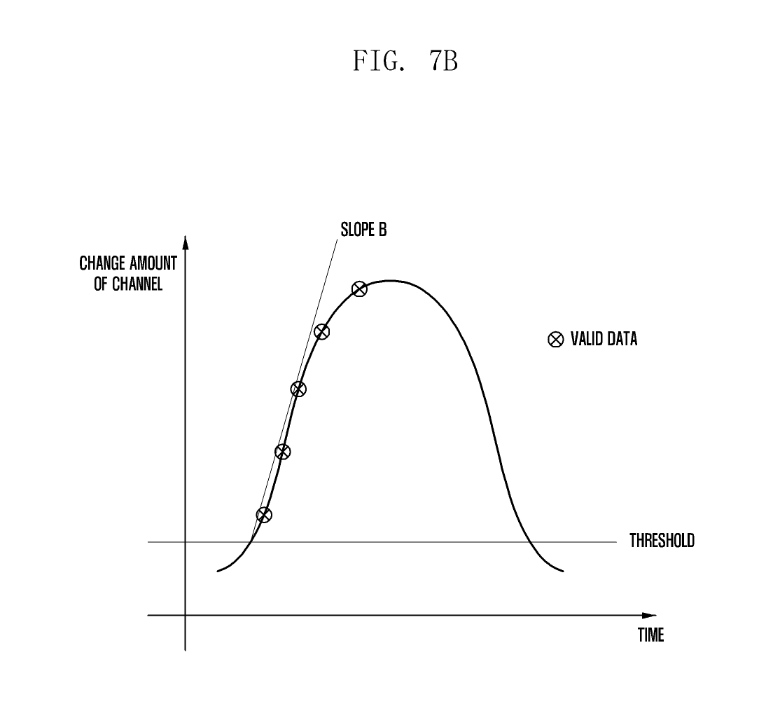

FIGS. 6A and 6B are views illustrating a method for recognizing a speed of a gesture according to the size of an external object by an electronic device according to an embodiment of the present disclosure. FIGS. 7A and 7B are graphs illustrating a method for recognizing a speed of a gesture according to the size of an external object by an electronic device according to an embodiment of the present disclosure.

Referring to FIG. 6A, the electronic device 200 may receive, through the gesture sensor 240A, a gesture in which a palm 300 of the user faces the screen of the electronic device 200. Alternatively, referring to FIG. 6B, the electronic device 200 may receive, through the gesture sensor 240A, a gesture in which a side of a hand (i.e., a knife) 400 of the user faces the screen of the electronic device 200. Here, the hand knife implies that the palm of the user does not face the screen of the electronic device 200 but is nearly perpendicular to the screen thereof. In addition, the hand knife may refer to an object (e.g., a finger) having a smaller area than that of the palm.

The electronic device 200 may not only calculate or determine the speed and direction of the gesture, but may also calculate an area of the object, that has made the gesture, by using the valid data. With reference to FIGS. 7A and 7B, a description will be made below of a method in which the electronic device 200 calculates an area of an object, that has made a gesture, by using valid data.

The electronic device 200 may determine an area of the object, that has made the gesture, by using at least one of slopes of valid data before the number of valid data or a sum of change amounts of channels reaches a highest point.

For example, if the number of valid data that the electronic device 200 calculates when the user makes a gesture by using the palm 300 of the user is compared with the number of valid data that the electronic device 200 calculates when the user makes a gesture by using the hand knife or finger 400 of the user, the former is greater than the latter.

The electronic device 200 does not determine that the palm 300, that causes the number of the valid data to be larger, has a low speed and the hand knife or finger 400, that causes the number of the valid data to be smaller, has a high speed, but may determine a speed of a gesture by additionally or alternatively comparing slopes before the sum of the change amounts of the channels reaches the highest point (e.g., until the sum of the change amounts of the channels reaches a point corresponding to 80% of the highest point). The electronic device 200 may determine the speed of the gesture not only by using the number of the valid data but also by additionally or alternatively comparing slopes before the sum of the change amounts of the channels reaches the highest point.

Referring to FIGS. 7A and 7B, an input from the palm 300 requiring a long gesture input time period causes the number of valid data to be greater than in the case of an input from the hand knife or finger 400. However, it can be noted that, within a predetermined range of errors, a slope of a sum of change amounts of channels in the case of the input from the palm 300 is similar or identical to a slope of a sum of change amounts of channels in the case of the input from the hand knife or finger 400. The electronic device 200 may discriminate between the input from the palm 300 and the input from the hand knife or finger 400 on the basis of the number of valid data and a slope of a sum of change amounts of channels.

As an example, the electronic device 200 may determine an area of an object, that has made a gesture, not only by using the number of valid data but also by additionally or alternatively comparing slopes before a sum of change amounts of channel A, channel B, channel C and channel D reaches a highest point.

The processor 120 may recognize a speed of a gesture (or movement of an object) by comparing the calculated number of the valid data with at least one reference value (e.g., a first or second reference value). Additionally or alternatively, the processor 120 may recognize an area of the object, that has made the gesture, by comparing slopes of sums of change amounts of channels.

As an example, the processor 120 may recognize a speed of a gesture (or movement of an object) by comparing the calculated number of the valid data with at least one reference value. The processor 120 may recognize an area of the object, that has made the gesture, by comparing slopes of sums of change amounts of channel A, channel B, channel C and channel D. The electronic device 200 may recognize an accurate speed of the gesture by using the number of valid data or a slope of a sum of change amounts of channels, regardless of a position and direction of a hand (e.g., a palm, or a hand knife or finger) of the user.

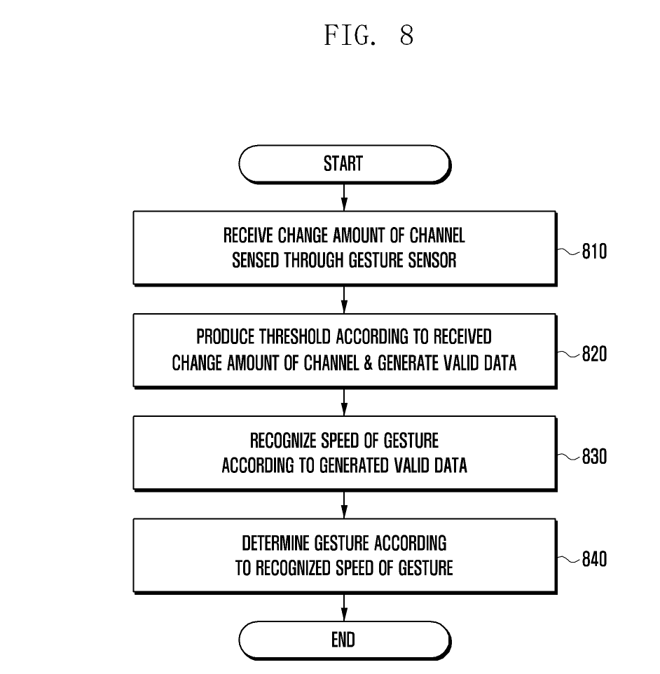

FIG. 8 is a flowchart illustrating a method for recognizing a gesture by an electronic device according to an embodiment of the present disclosure.

Referring to FIG. 8, the electronic device 200 may receive a change amount of a channel (or a change amount of intensity of the received light) sensed through the gesture sensor 240A in operation 810. That is, the processor 120 may receive the change amount of the channel (or the change amount of the intensity of the received light) sensed through the gesture sensor 240A. The gesture sensor 240A may include the light-emitting unit for emitting light, which has a frequency corresponding to infrared light, to an object (e.g., a hand) and the light reception unit for receiving light reflected by the object approaching the electronic device 200. The gesture sensor 240A may receive, through the light reception unit, light reflected when infrared light emitted by the light-emitting unit hits the object, may sense a change amount of intensity of the reflected light, and thereby may sense a movement of the object and a distance to the object. The light reception unit of the gesture sensor 240A may include at least one channel. According to an embodiment of the present disclosure, the light reception unit of the gesture sensor 240A may include four channels A, B, C and D which face the left, right, upper and lower directions, respectively.

In operation 820, the electronic device 200 may produce a threshold according to the received change amount of the channel (or the change amount of the intensity of the received light), and may generate valid data. As an example, the threshold may be predetermined or may be dynamically changed. That is, the processor 120 may produce the threshold according to the received change amount of the channel, and may generate the valid data. In an embodiment, the electronic device 200 or the processor 120 may calculate the number of the valid data on the basis of the generated valid data. Further, by using data received through one or more channels, the electronic device 200 or the processor 120 may calculate a difference between a change amount of a channel and that of another channel (e.g., a difference between a change amount of channel A and that of channel B) or a sum of the change amounts of the one or more channels. The electronic device 200 or the processor 120 may determine a direction of a gesture (or movement of an object) by using the difference between the change amount of the channel and that of another channel and the sum of the change amounts of the one or more channels. The electronic device 200 or the processor 120 may produce the threshold, which is used to determine that the gesture has occurred, by using the difference between the change amount of the channel and that of another channel and the sum of the change amounts of the channels. Also, the electronic device 200 or the processor 120 may generate the valid data by taking a sample per unit time of the sum of the change amounts of the channels which exceeds the threshold.

As an example, the electronic device 200 or the processor 120 may produce the threshold, which is used to determine that the gesture (or the movement of the object) has occurred, by using the difference between the change amount of channel A and that of channel B, a difference between a change amount of channel C and that of channel D, and a sum of the change amounts of the channels. The electronic device 200 or the processor 120 may generate the valid data by taking a sample per unit time of the sum of the change amounts of the channels which exceeds the threshold.

In operation 830, the electronic device 200 or the processor 120 may recognize a speed of the gesture according to the generated valid data. When the number of the generated valid data is less than the first reference value, the electronic device 200 or the processor 120 may determine that the gesture (or the movement of the object) is a gesture having a first speed. Alternatively, when the number of the generated valid data is greater than the second reference value, the electronic device 200 or the processor 120 may determine that the gesture is a gesture having a second speed. Alternatively, when the number of the generated valid data is greater than the first reference value and is less than the second reference value, the electronic device 200 or the processor 120 may determine that the gesture is a gesture having a third speed. The first or second reference value is used to calculate the speed of the valid data, and may be the number of valid data which is previously or dynamically determined. The second reference value is greater than the first reference value. The number of valid data determined as the second reference value implies that there are more valid data than in the case of the number of valid data determined as the first reference value. The electronic device 200 or the processor 120 may determine that the gesture having the first speed is fastest among the gestures having the first speed to the third speed. Alternatively, the electronic device 200 or the processor 120 may determine that the gesture having the second speed is slowest among the gestures having the first speed to the third speed. Alternatively, the electronic device 200 or the processor 120 may determine that, among the gestures having the first speed to the third speed, the gesture having the third speed is a gesture having a speed ranging between the first speed and the second speed.

In operation 840, the electronic device 200 or the processor 120 may determine the gesture (e.g., may determine the speed of the gesture and the object that has made the gesture) according the generated valid data. The electronic device 200 or the processor 120 may recognize the speed of the gesture (the movement of the object) by comparing the generated valid data with a reference value. Additionally or alternatively, the electronic device 200 or the processor 120 may recognize an area of the object, that has made the gesture, by using a slope of the sum of the change amounts of the one or more channels.

The electronic device 200 or the processor 120 may determine the speed of the gesture and the size of the object, that has made the gesture, according the generated valid data.

For example, the electronic device 200 or the processor 120 may accurately determine the gesture regardless of an angle of the hand (e.g., whether the object that has made the gesture is a hand knife or palm) of the user who has made the gesture. Various functions may be performed according to the determined gesture. Further, the electronic device 200 or the processor 120 may determine the angle of the hand of the user depending on the gesture, and thus may perform various functions depending on the angle of the hand.

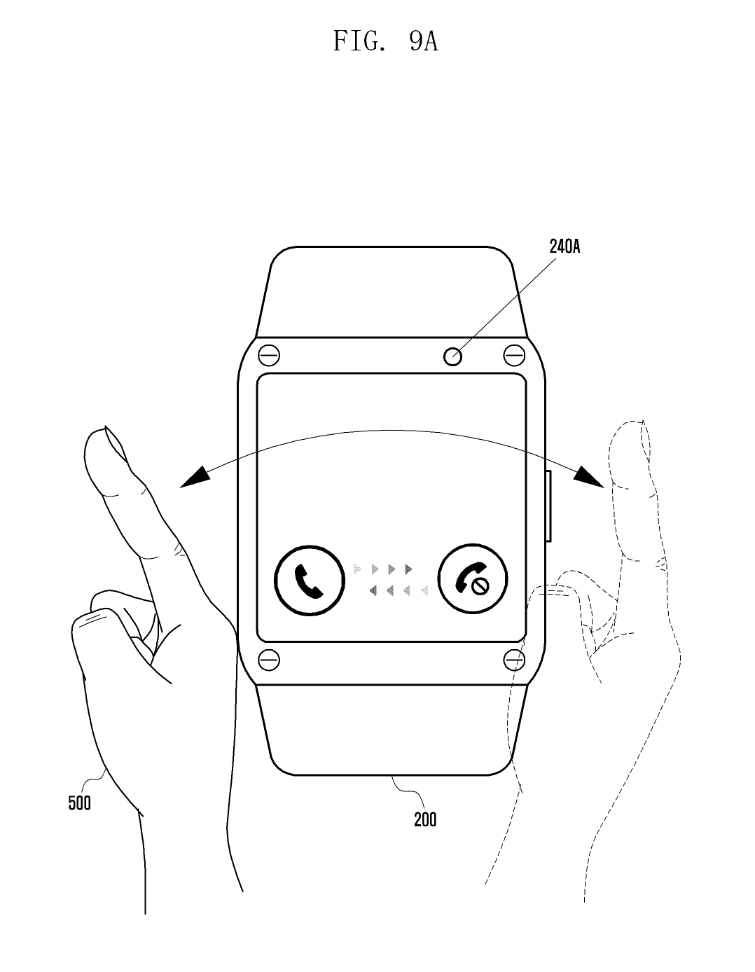

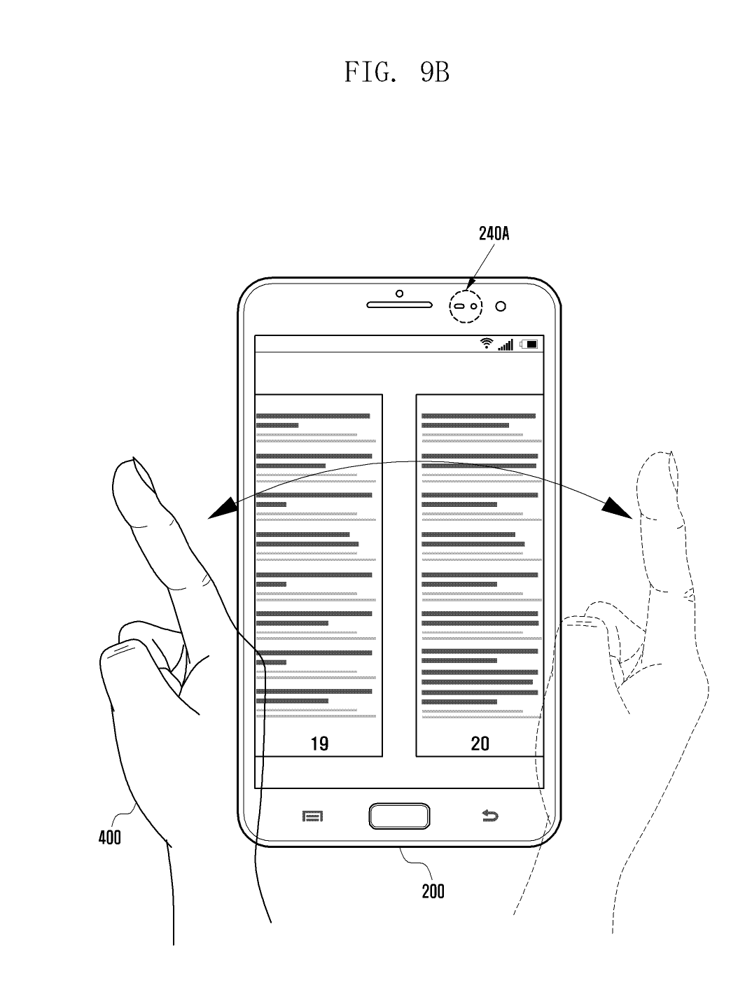

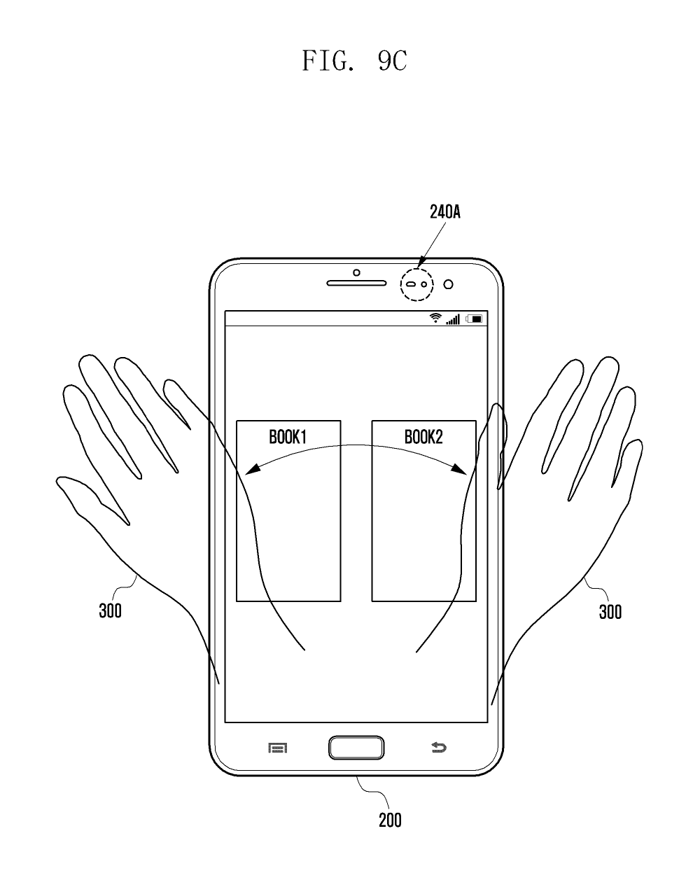

FIGS. 9A to 9C are views illustrating examples of a user interface displayed by using a method for recognizing a gesture according to various embodiments of the present disclosure.

Referring to FIG. 9A, when the electronic device 200 is a wearable display device such as a wristwatch, it may not be easy for the electronic device 200 to have enough area to include the input device 250. Alternatively, when the electronic device 200 receives a user input signal from the user who uses the palm, the accuracy of the input may be low. However, according to embodiments of the present disclosure, the electronic device 200 may receive an accurate gesture input regardless of the size of an external object that applies the gesture input to the electronic device 200. The electronic device 200 enables the user to receive a telephone call by using a finger gesture 500 of the user.

The electronic device 200 may determine the size of the external object that applies the gesture input to the electronic device 200, and thus may receive the accurate gesture input. For example, the electronic device 200 may determine an angle of the hand of the user depending on a gesture, and thus may perform various functions depending on the angle of the hand. Although input speeds of gestures made by different external objects are identical to each other, the electronic device 200 may display different user interfaces according to areas of the different external objects.

Referring to FIG. 9B, when receiving a gesture made by the hand knife or finger 400 of the user while displaying an electronic document, the electronic device 200 may perform a function of turning over pages of the electronic document.

Referring to FIG. 9C, when receiving a gesture made by the palm 300 of the user while displaying an electronic document, the electronic device 200 may perform a function of selecting another book rather than the function of turning over pages of the electronic document.

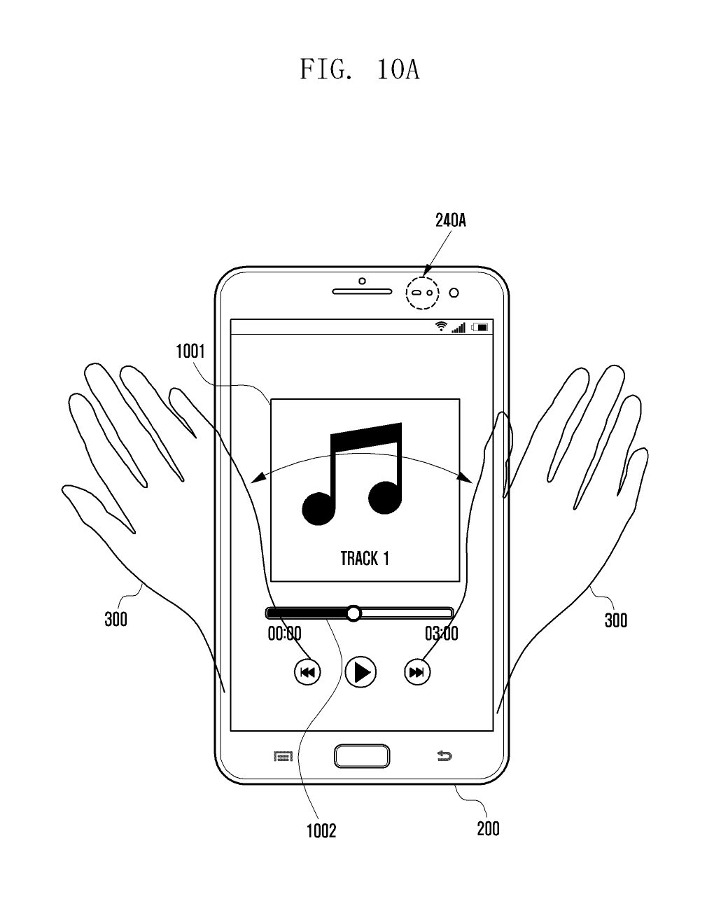

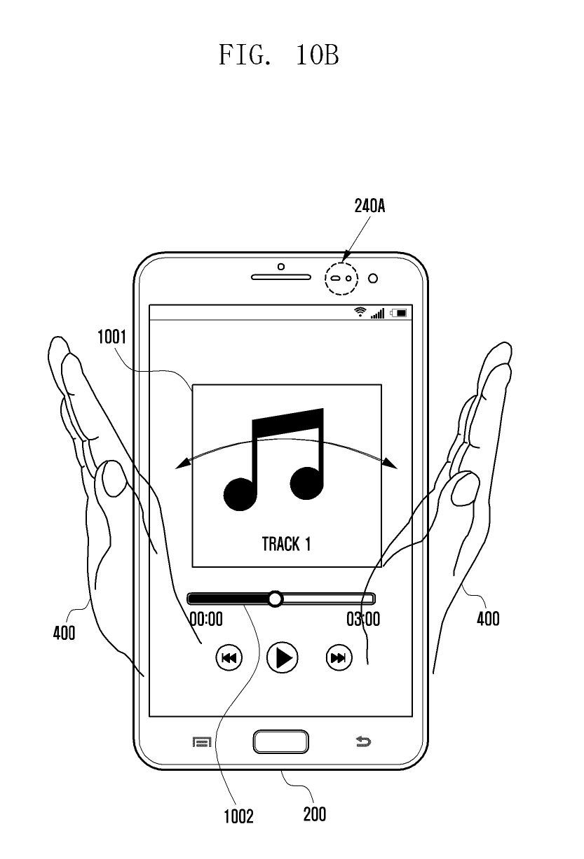

FIGS. 10A and 10B are views illustrating examples of a user interface displayed by using a method for recognizing a gesture according to various embodiments of the present disclosure.

Referring to FIG. 10A, when receiving a gesture made by the palm 300 of the user while reproducing music, the electronic device 200 may perform a function of changing the tempo of the music which is being reproduced. For example, when receiving a gesture made by the palm 300 of the user while reproducing music, the electronic device 200 may perform a function of changing a progress bar 1002 for the music which is being reproduced.

Referring to FIG. 10B, when receiving a gesture made by the hand knife or finger 400 of the user while reproducing music, the electronic device 200 may perform a function of selecting another music rather the function of changing the tempo of the music which is being reproduced. For example, when receiving a gesture made by the hand knife or finger 400 of the user while reproducing music, the electronic device 200 may display another music album 1001.

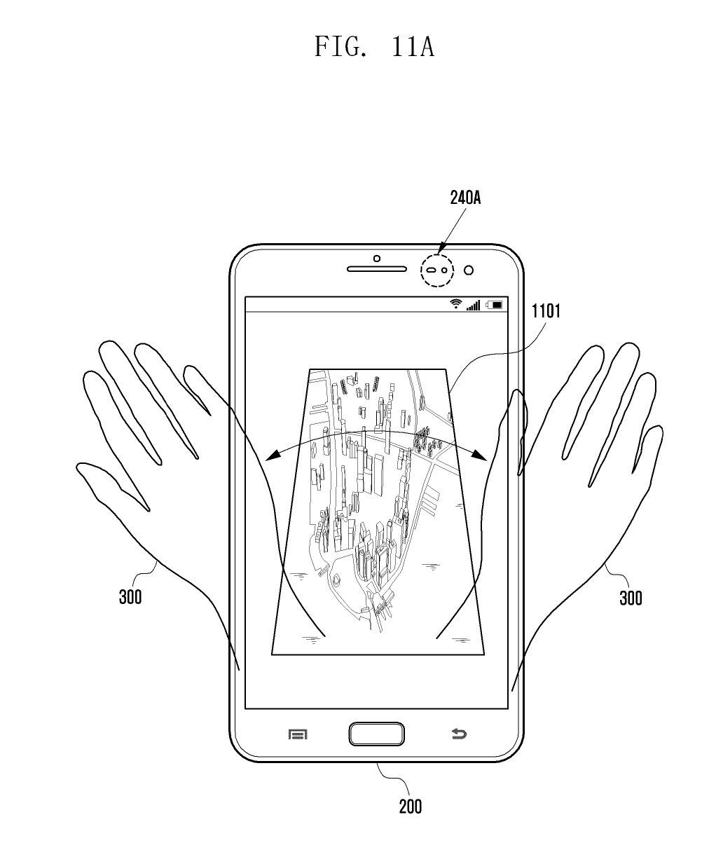

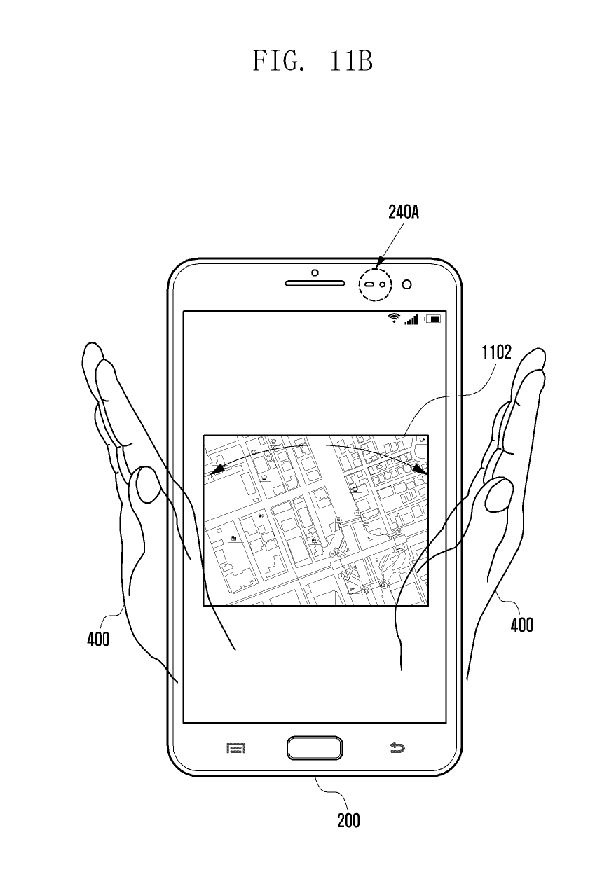

FIGS. 11A and 11B are views illustrating examples of a user interface displayed by using a method for recognizing a gesture according to various embodiments of the present disclosure.

Referring to FIG. 11A, when receiving a gesture made by the palm 300 of the user while displaying a map, the electronic device 200 may perform a function of changing the map being displayed to an aerial view 1101.

Referring to FIG. 11B, when receiving a gesture made by the hand knife or finger 400 of the user while displaying a map, the electronic device 200 may not perform the function of changing the map being displayed to the aerial view 1101, but may perform a function of differently displaying a position in the map 1102 being displayed.

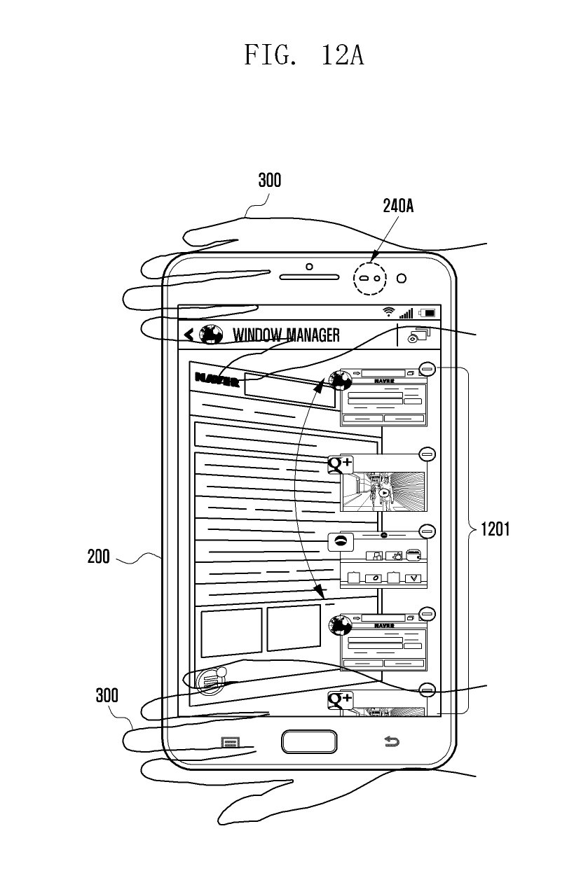

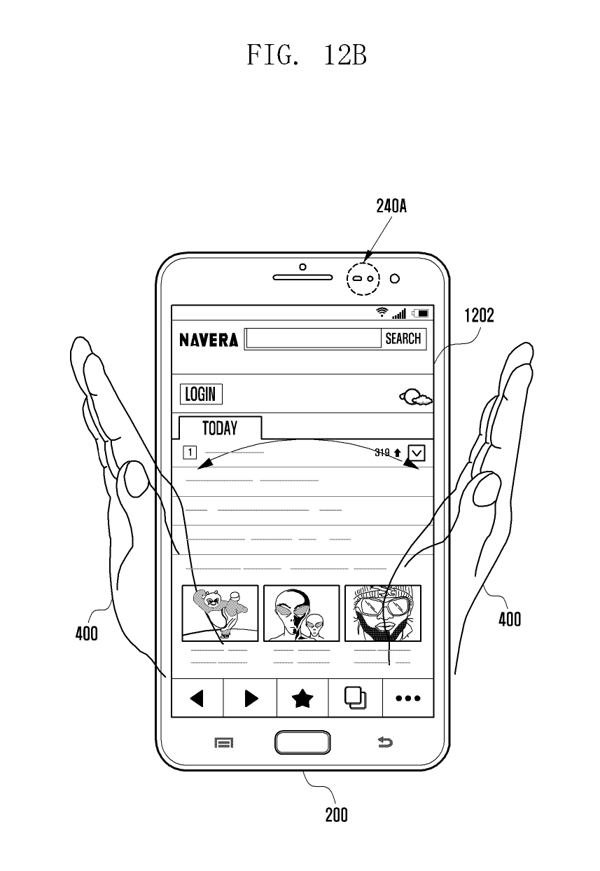

FIGS. 12A and 12B are views illustrating examples of a user interface displayed by using a method for recognizing a gesture according to various embodiments of the present disclosure.

Referring to FIG. 12A, when receiving a gesture made by the palm 300 of the user while displaying an Internet browser, the electronic device 200 may perform a function of changing a window of the Internet browser being displayed to another Internet browser window 1201.

Referring to FIG. 12B, when receiving a gesture made by the hand knife or finger 400 of the user while displaying an Internet browser, the electronic device 200 may not perform the function of changing the window of the Internet browser being displayed to another Internet browser window 1201, but may perform a function 1202 of displaying a previous or next page of the Internet browser being displayed.

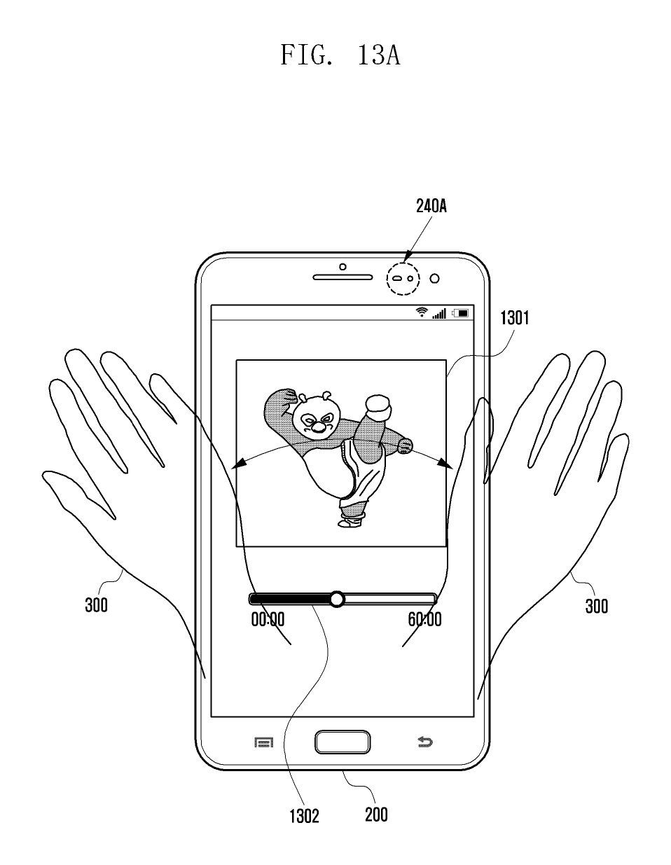

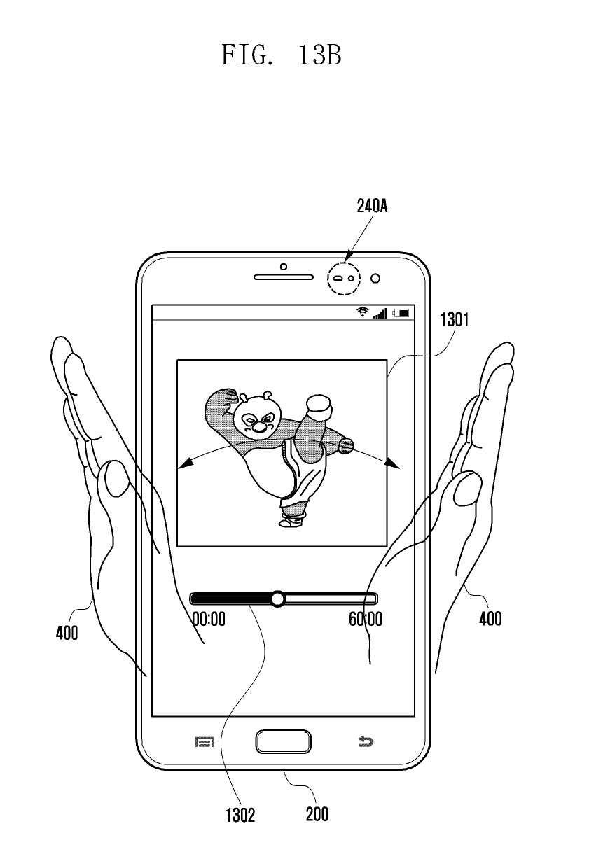

FIGS. 13A and 13B are views illustrating examples of a user interface displayed by using a method for recognizing a gesture according to various embodiments of the present disclosure.

Referring to FIG. 13A, when receiving a gesture made by the palm 300 of the user while reproducing a moving image, the electronic device 200 may perform a function of changing the speed of the moving image which is being reproduced. For example, when receiving a gesture made by the palm 300 of the user while reproducing a moving image, the electronic device 200 may perform a function of changing a progress bar 1302 for the moving image which is being reproduced.

Referring to FIG. 13B, when receiving a gesture made by the hand knife or finger 400 of the user while reproducing a moving image, the electronic device 200 may not perform the function of changing the speed of the moving image being reproduced, but may perform a function of selecting another moving image. For example, when receiving a gesture made by the hand knife or finger 400 of the user while reproducing a moving image, the electronic device 200 may display another moving image 1301.

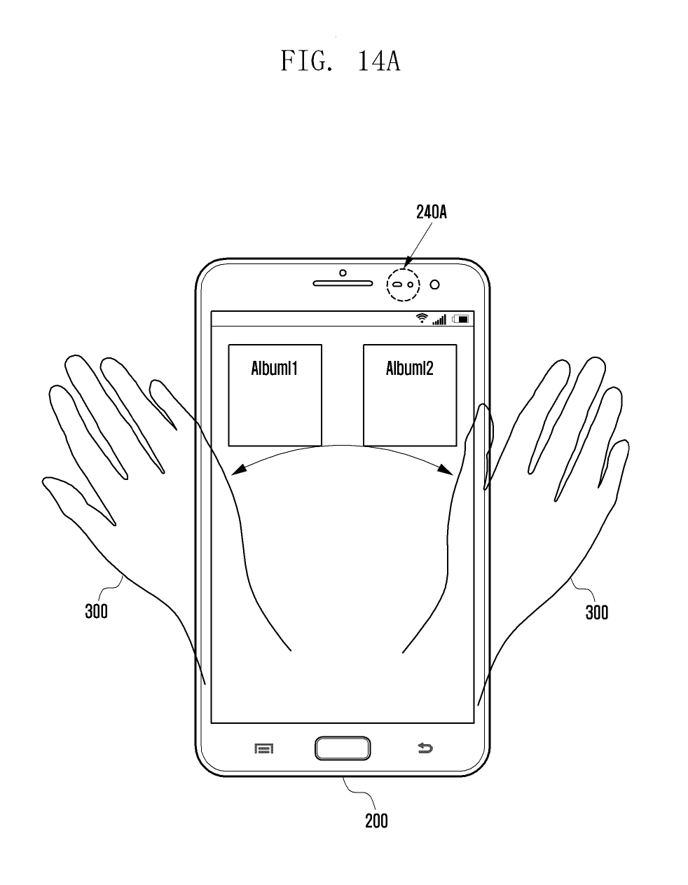

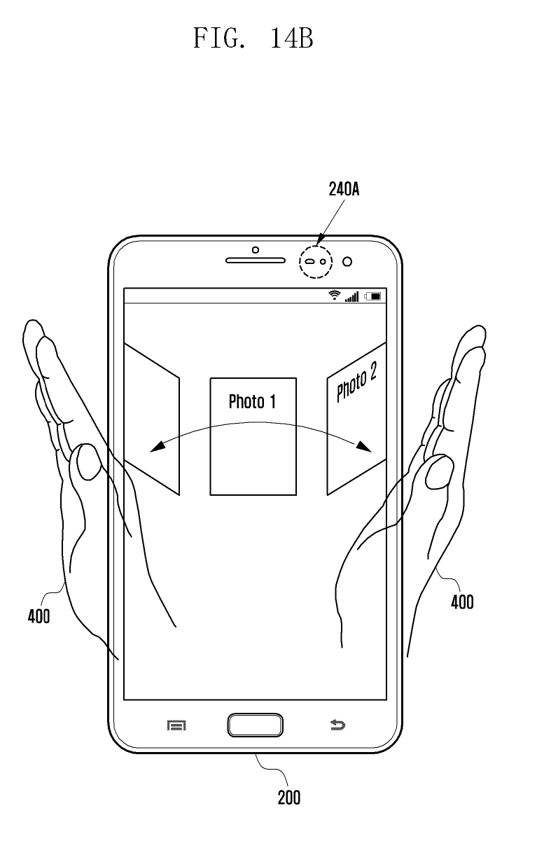

FIGS. 14A and 14B are views illustrating examples of a user interface displayed by using a method for recognizing a gesture according to various embodiments of the present disclosure.

Referring to FIG. 14A, when receiving a gesture made by the palm 300 of the user while displaying a photograph, the electronic device 200 may perform a function of changing an album including another photograph.

Referring to FIG. 14B, when receiving a gesture made by the hand knife or finger 400 of the user while displaying a photograph, the electronic device 200 may not perform the function of changing the album, but may perform a function of selecting another photograph.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for recognizing a gesture by an electronic device, the method comprising:
sensing a change amount of a signal strength received through one or more channels by using a gesture sensor including the one or more channels;
generating valid data according to the sensed change amount of the signal strength;
recognizing a speed of the gesture according to the generated valid data; and
determining the gesture according to the sensed change amount of the signal strength and the generated valid data.

2. The method of claim 1, wherein the generating of the valid data according to the sensed change amount of the signal strength comprises:
producing a threshold based on a difference between the change amount of the signal strength sensed through a channel and the change amount of the signal strength sensed through another channel, and a sum of the change amounts of the signal strengths sensed through the one or more channels; and
generating the valid data by taking a sample per unit time of the sum of the change amounts of the signal strengths according to the threshold.

3. The method of claim 2, wherein the generating of the valid data by taking the sample per the unit time of the sum of the change amounts of the signal strengths according to the threshold comprises taking the sample per the unit time of the sum of the change amounts of the signal strengths which is greater than or equal to the threshold.

4. The method of claim 1, wherein the recognizing of the speed of the gesture according to the generated valid data comprises calculating the speed of the gesture by comparing the number of the generated valid data with a determined reference value.

5. The method of claim 4, wherein the determining of the gesture according to the sensed change amount of the signal strength and the generated valid data further comprises determining an area of an object, that has made the gesture, according to the sensed change amount of the signal strength and the generated valid data.

6. The method of claim 5, wherein the determining of the area of the object, that has made the gesture, according to the sensed change amount of the signal strength and the generated valid data comprises determining the area of the object according to a slope of the sensed change amount of the signal strength, and the number of the valid data with respect to the sensed change amount of the signal strength.

7. The method of claim 5, wherein the determining of the gesture according to the sensed change amount of the signal strength and the generated valid data further comprises performing various functions of the electronic device according to the speed of the gesture and the area of the object.

8. The method of claim 7, wherein the performing of the various functions of the electronic device according to the speed of the gesture and the area of the object comprises displaying different user interfaces according to areas of different objects although speeds of gestures made by the different objects are identical to each other.

9. An electronic device comprising:
a display;
a gesture sensor; and
a processor,
wherein the processor is configured to:
sense a change amount of a signal strength received through one or more channels by using a gesture sensor including the one or more channels;
generate valid data according to the sensed change amount of the signal strength, recognizes a speed of the gesture according to the generated valid data; and
determine the gesture according to the sensed change amount of the signal strength and the generated valid data.

10. The electronic device of claim 9, wherein the processor is further configured to:
produce a threshold based on a difference between the change amount of the signal strength sensed through a channel and the change amount of the signal strength sensed through another channel, and a sum of the change amounts of the signal strengths sensed through the one or more channels; and
generate the valid data by taking a sample per unit time of the sum of the change amounts of the signal strengths according to the threshold.

11. The electronic device of claim 10, wherein the processor is further configured to take the sample per the unit time of the sum of the change amounts of the signal strengths which is greater than or equal to the threshold.

12. The electronic device of claim 9, wherein the processor is further configured to calculate the speed of the gesture by comparing the number of the generated valid data with a determined reference value.

13. The electronic device of claim 12, wherein the processor is further configured to determine an area of an object, that has made the gesture, according to the sensed change amount of the signal strength and the generated valid data.

14. The electronic device of claim 13, wherein the processor is further configured to determine the area of the object according to a slope of the sensed change amount of the signal strength, and the number of the valid data with respect to the sensed change amount of the signal strength.

15. The electronic device of claim 13, wherein the processor is further configured to perform various functions of the electronic device according to the speed of the gesture and the area of the object.

16. The electronic device of claim 15, wherein different user interfaces are displayed through the display according to areas of different objects although speeds of gestures made by the different objects are identical to each other.

17. The electronic device of claim 9, wherein the gesture sensor comprises one of a proximity sensor and an illuminance sensor.

18. The electronic device of claim 9, wherein the electronic device comprises a wearable device, and
wherein the wearable device performs an operation of receiving a telephone call and an operation of turning over pages according to the gesture.

19. A non-transitory computer-readable storage medium storing instructions that, when executed, cause at least one processor to perform the method of claim 1.
